(19) United States
(12) Patent Application Publication
(10) Pub. No.: US 2017/0172841 A1
(43) Pub. Date: Jun. 22, 2017

(54) EJACULATION PROMOTION APPARATUS

(71) Applicant: DAVID SINDELAR, San Diego, CA (US)

(72) Inventor: DAVID SINDELAR, San Diego, CA (US)

(21) Appl. No.: 15/454,746

(22) Filed: Mar. 9, 2017

(51) Int. Cl. A61H 19/00; A61F 5/00; A61M 3/00

(52) U.S. Cl. CPC A61H 19/32; A61H 19/44; A61H 2201/1669; A61H 2201/12; A61H 2205/087

(57) ABSTRACT

Ejaculation promotion apparatuses. Apparatuses for promoting ejaculation may include a sensory component coupled to a shaft at or near a first end of the shaft, a bar coupled to the shaft at or near a second end of the shaft, a rail coupled to the bar to permit the bar to move along the length of rail, a pin coupled to a wheel and inserted through a slot of the bar, and a motor coupled to the wheel. A housing includes the bar, the rail, the pin, and the wheel. Operation of the motor rotates the wheel, which moves the pin between two ends of the slot. Movement of the pin between the two ends of the slot moves the bar between two ends of the rail. Movement of the bar between the two ends of the rail moves a portion of the shaft in and out of the housing.

### BACKGROUND

Apparatuses used for promoting ejaculation are often bulky, use exposed mechanical features that can cause injury during accidental contact with those mechanical features, or provide unsatisfactory vibratory sensation. New and improved apparatuses for promoting ejaculation are needed.

### BRIEF DESCRIPTION OF THE DRAWINGS

FIG. 1A and FIG. 1B depict a first ejaculation promotion apparatus from different perspective views.

FIG. 2 depicts a top side view of a first ejaculation promotion apparatus.

FIG. 3 depicts a front side view of a first ejaculation promotion apparatus.

FIG. 4 depicts a rear side view of a first ejaculation promotion apparatus.

FIG. 5 depicts a left side view of a first ejaculation promotion apparatus.

FIG. 6 depicts a right side view of a first ejaculation promotion apparatus.

FIG. 7 depicts a first cross sectional view of a first ejaculation promotion apparatus.

FIG. 8A through FIG. 8D depict a second cross sectional view of a first ejaculation promotion apparatus, and illustrate movement of various components during operation of the first ejaculation promotion apparatus.

FIG. 9 depicts a top side view of a second ejaculation promotion apparatus.

FIG. 10 depicts a front side view of a second ejaculation promotion apparatus.

FIG. 11 depicts a rear side view of a second ejaculation promotion apparatus.

FIG. 12 depicts a left side view of a second ejaculation promotion apparatus.

FIG. 13 depicts a right side view of a second ejaculation promotion apparatus.

FIG. 14 depicts a first cross sectional view of a second ejaculation promotion apparatus.

FIG. 15 depicts a coupling of a slidable bar to a rail for use in an ejaculation promotion apparatus.

FIG. 16 depicts a top side view of a third ejaculation promotion apparatus with a sleeve as a sensory component.

FIG. 17 depicts a top side view of a fourth ejaculation promotion apparatus with a phallic-shaped sensory component coupled to a shaft using a left side coupling configuration.

FIG. 18A and FIG. 18B depict a top side view and a front side view of a fifth ejaculation promotion apparatus with a phallic-shaped sensory component coupled to a shaft using a top-side coupling configuration.

FIG. 19A and FIG. 19B depict a top side view and a front side view of a sixth ejaculation promotion apparatus with a ring-shaped sensory component coupled to a shaft using a top-side coupling configuration.

FIG. 20 depicts a top side view of a seventh ejaculation promotion apparatus with multiple ring-shaped sensory components coupled to a shaft using a top-side coupling configuration.

FIG. 21A and FIG. 21B illustrate different uses an ejaculation promotion apparatus.

### DETAILED DESCRIPTION

Described below are various apparatuses that transfer rotary motion of a motor to linear motion of a shaft in a compact way. Motion of the shaft moves a sensory component attached to the shaft. Movement of the sensory component is used for stimulation of a genital organ to promote ejaculation. The apparatuses described below advantageously create a safe environment where only a single shaft extends out of a protective housing. The length of movement by the shaft during operation, and hence the range of motion of the sensory component, provides a quality of stimulation that is similar to stimulation received from another human (e.g., during oral or sexual intercourse).

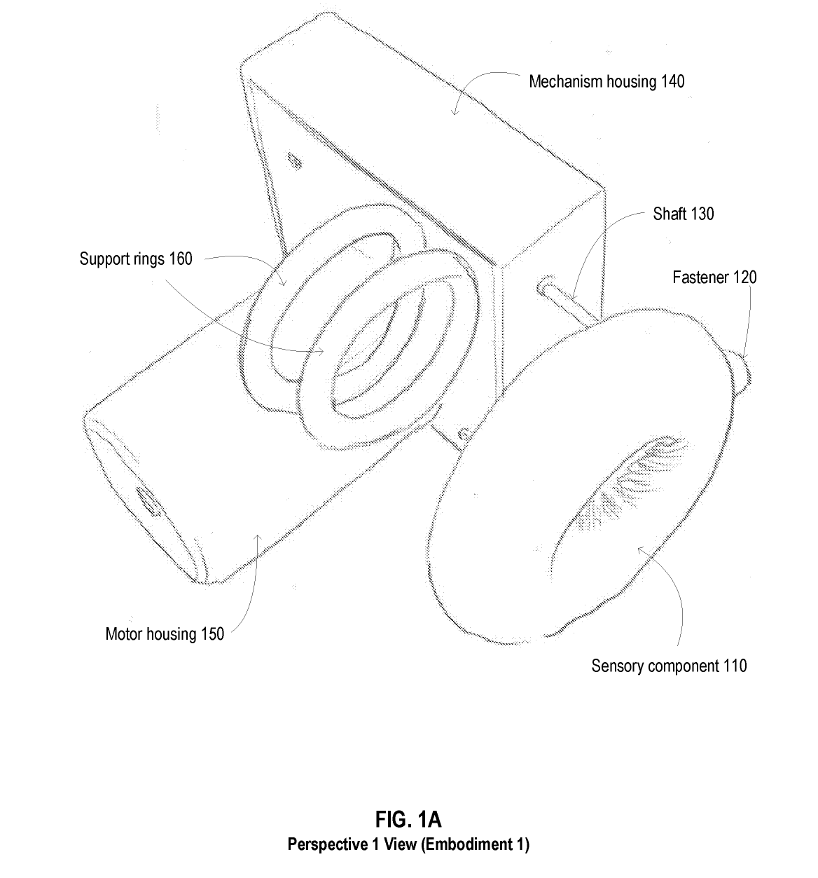

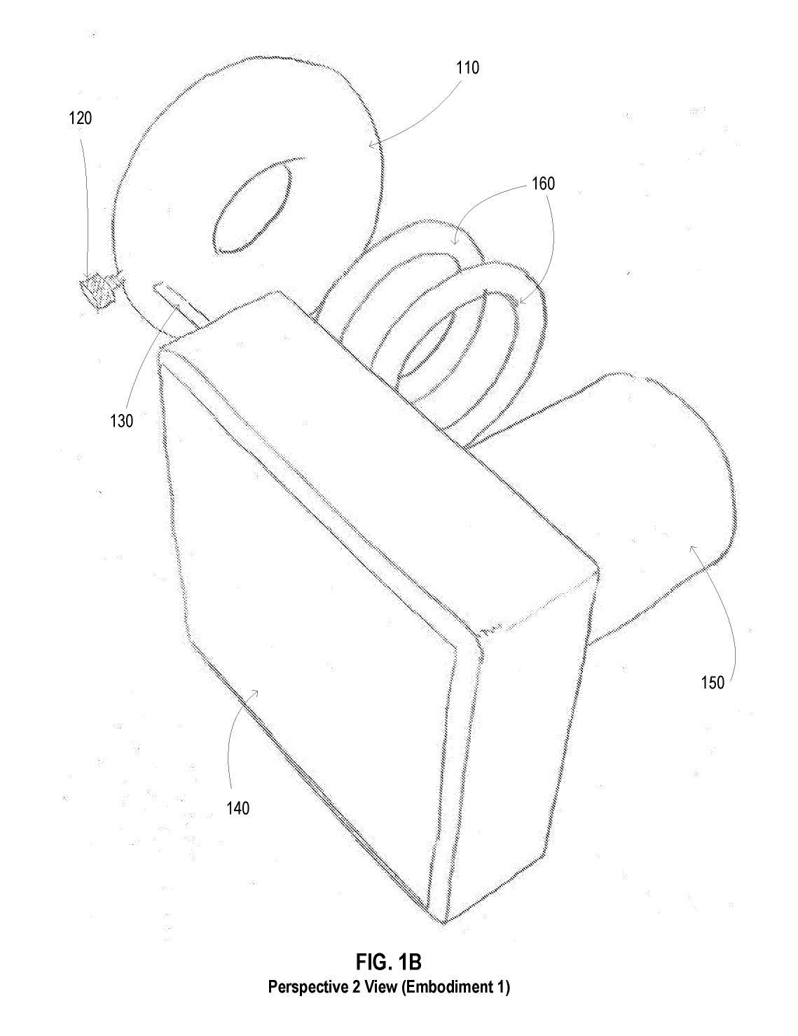

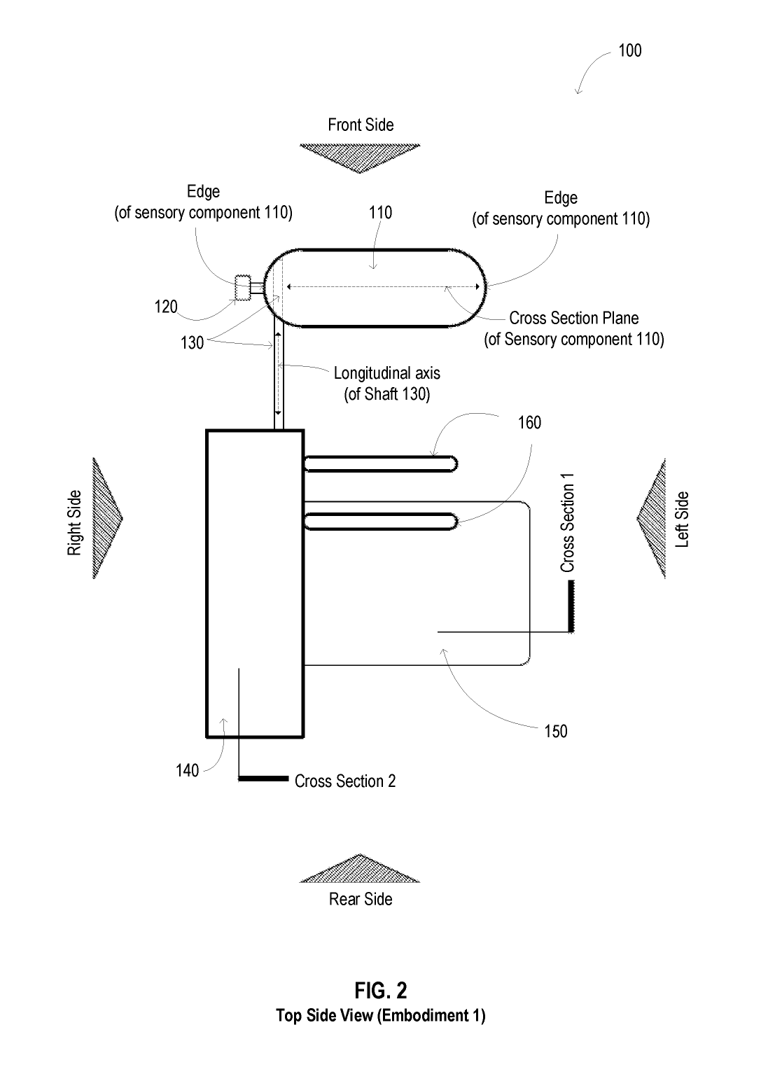

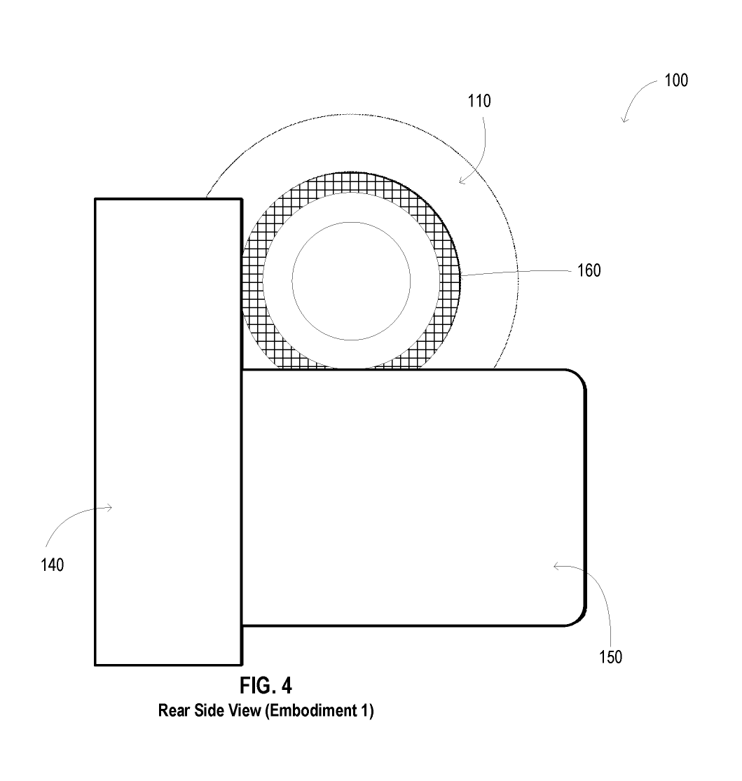

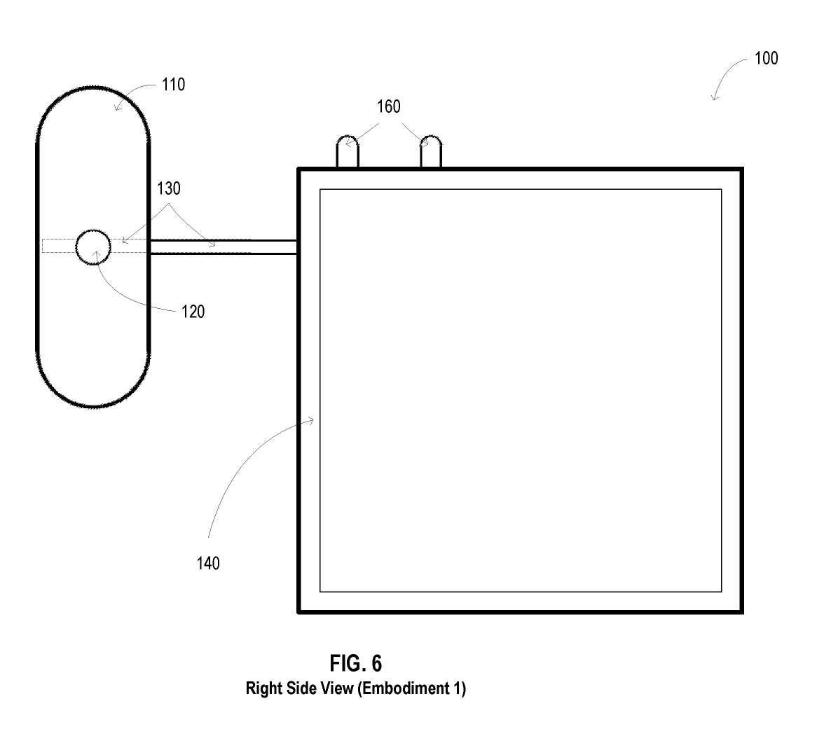

FIG. 1A and FIG. 1B depict an ejaculation promotion apparatus 100 from different perspective views. FIG. 2 through FIG. 6 respectively depict top side, front side, rear side, left side, and right side views of the apparatus 100.

The apparatus 100 includes various components, including a sensory component 110, a fastener 120, a shaft 130, a mechanism housing 140, a motor housing 150, and two support rings 160 that are coupled to a left side of the mechanism housing 140.

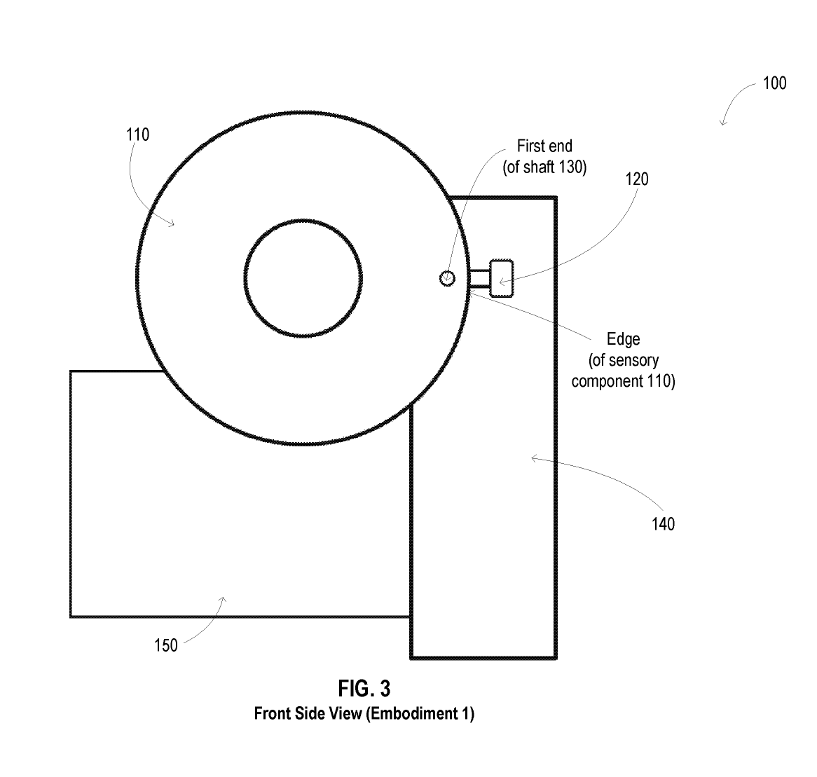

The sensory component 110 is detachably coupled to the shaft 130 at or near a first end of the shaft 130. As shown in FIG. 2 and FIG. 3, the part of the shaft 130 in contact with the sensory component 110 is positioned near an edge of the sensory component 110. The shaft 130 inserts into a cavity of the sensory component 110. Coupling of the sensory component 110 to the shaft 130 may be accomplished using different means, including an adhesive, a friction lock, the fastener 120 (e.g., a screw inserted into a threaded cavity of the sensory component 110 and making frictional contact with the shaft 130, or inserted into a cavity of the sensory component 110 and then into a threaded cavity of the shaft 130), or other known means for coupling two things. As shown in FIG. 2, a longitudinal axis between two ends of the shaft 130 and a cross sectional plane between two edges of the sensory component 110 are perpendicular to each other.

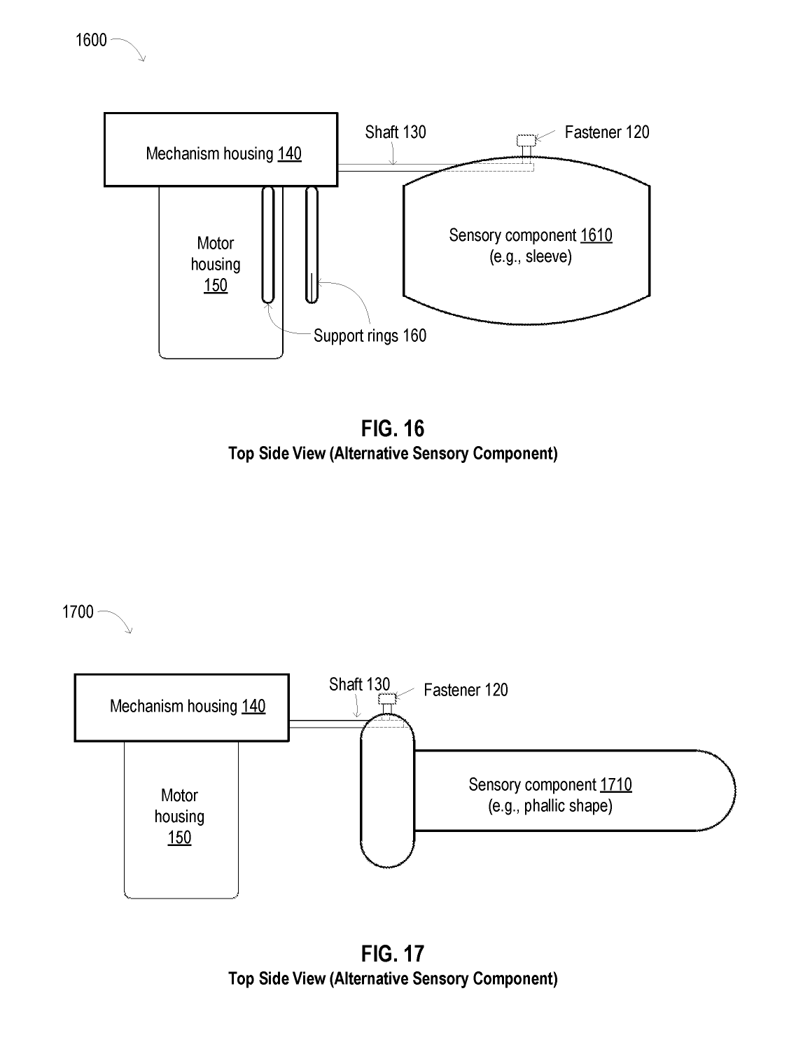

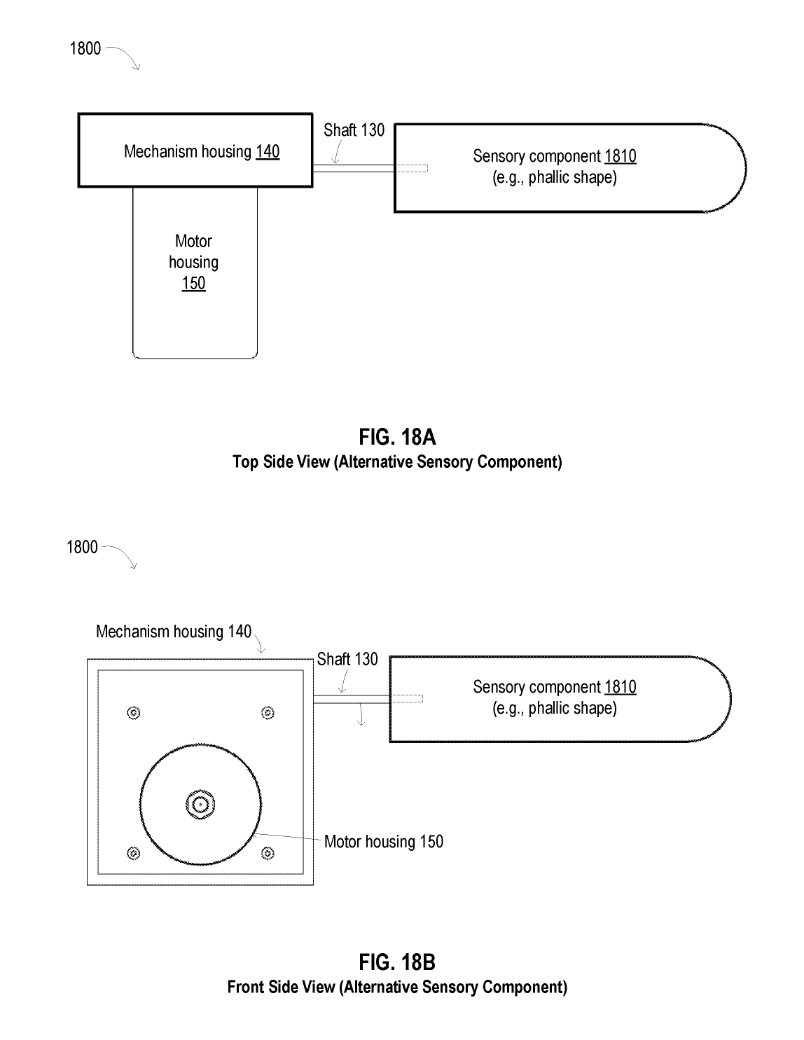

The shape of the sensory component 110 in FIG. 1A and FIG. 1B is illustrated as a ring shape (e.g., particularly a torus shape). Other shapes are contemplated, including those discussed later with reference to FIG. 16, FIG. 17, and FIG. 18A-FIG. 18B. Various materials may be used for the sensory component 110, including discussed in the materials section of this disclosure.

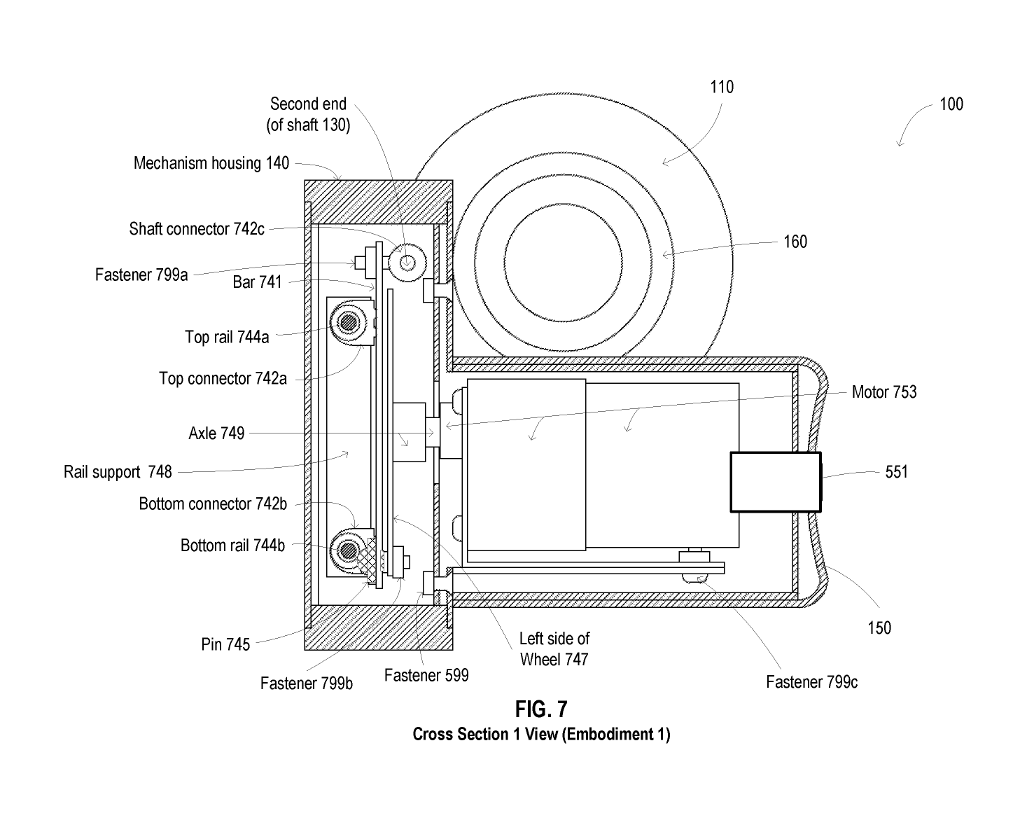

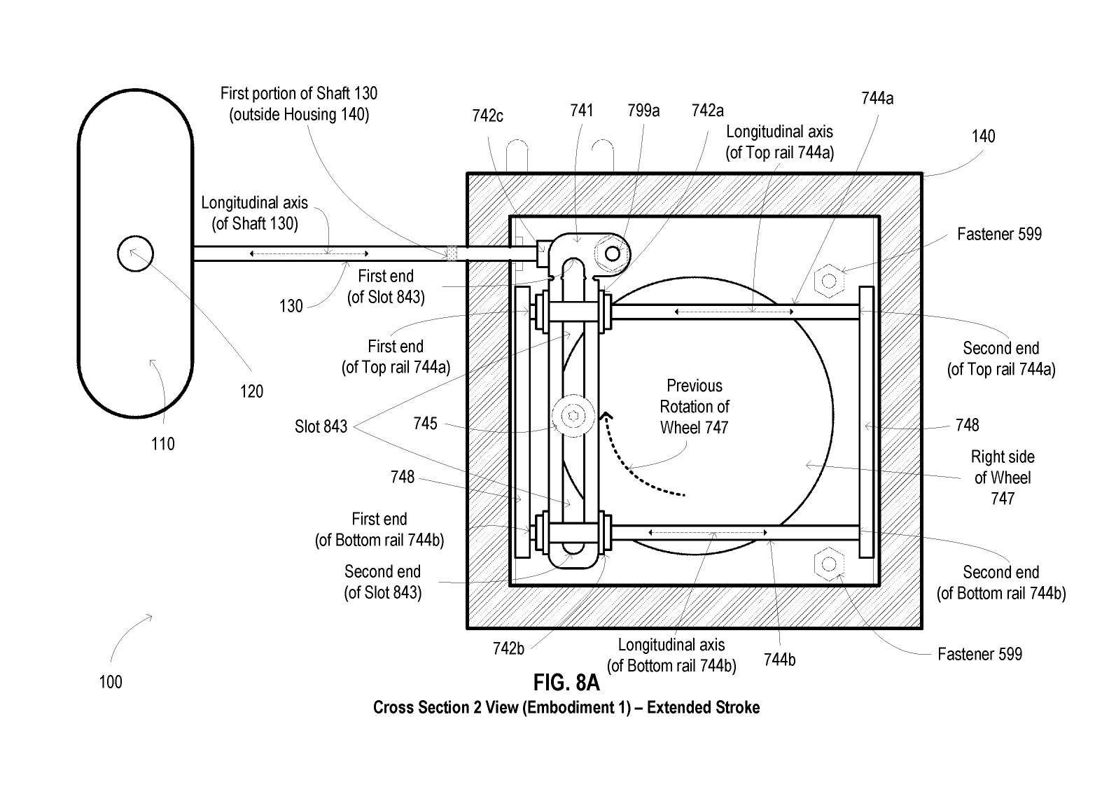

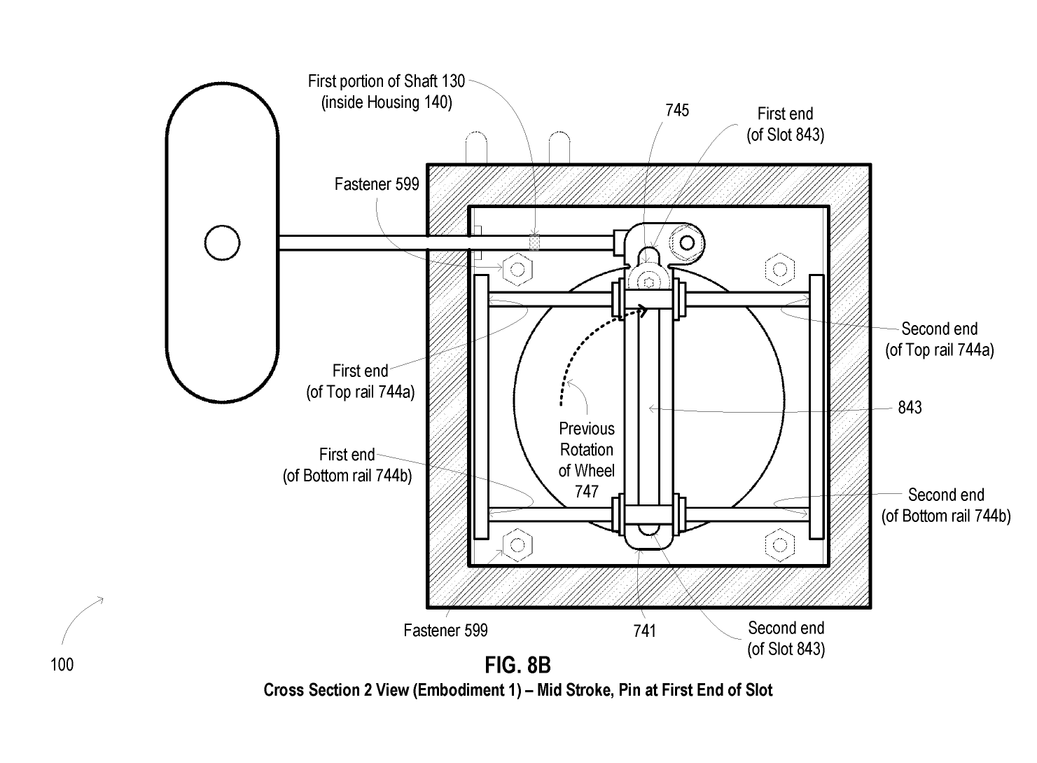

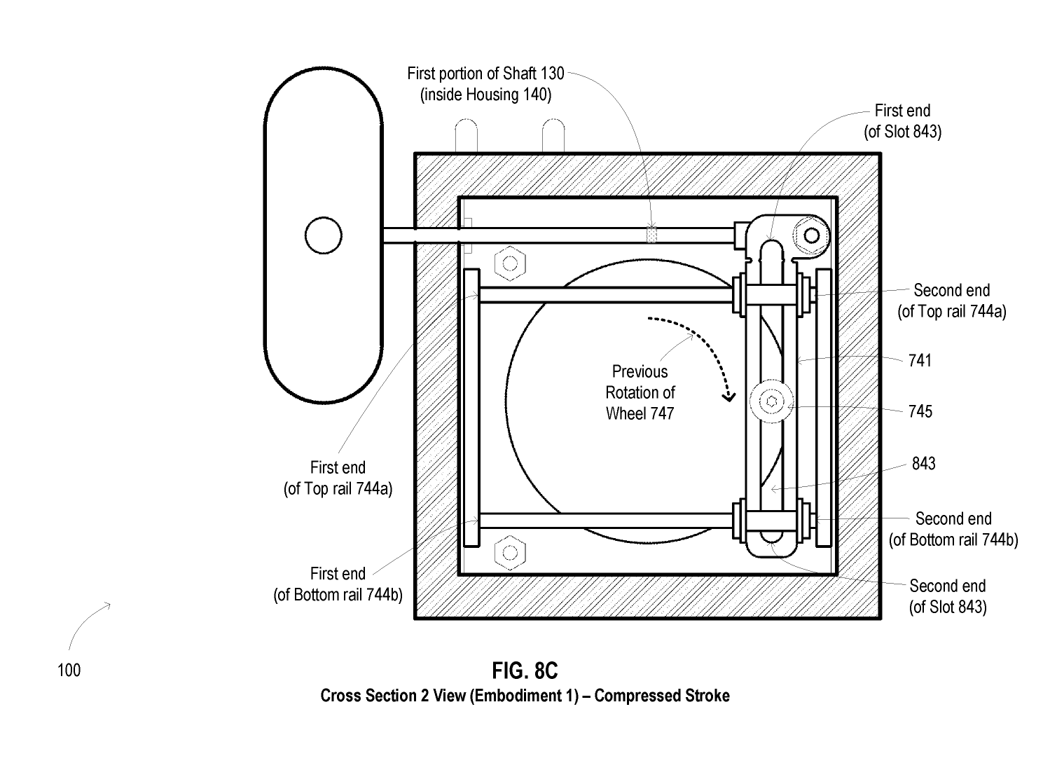

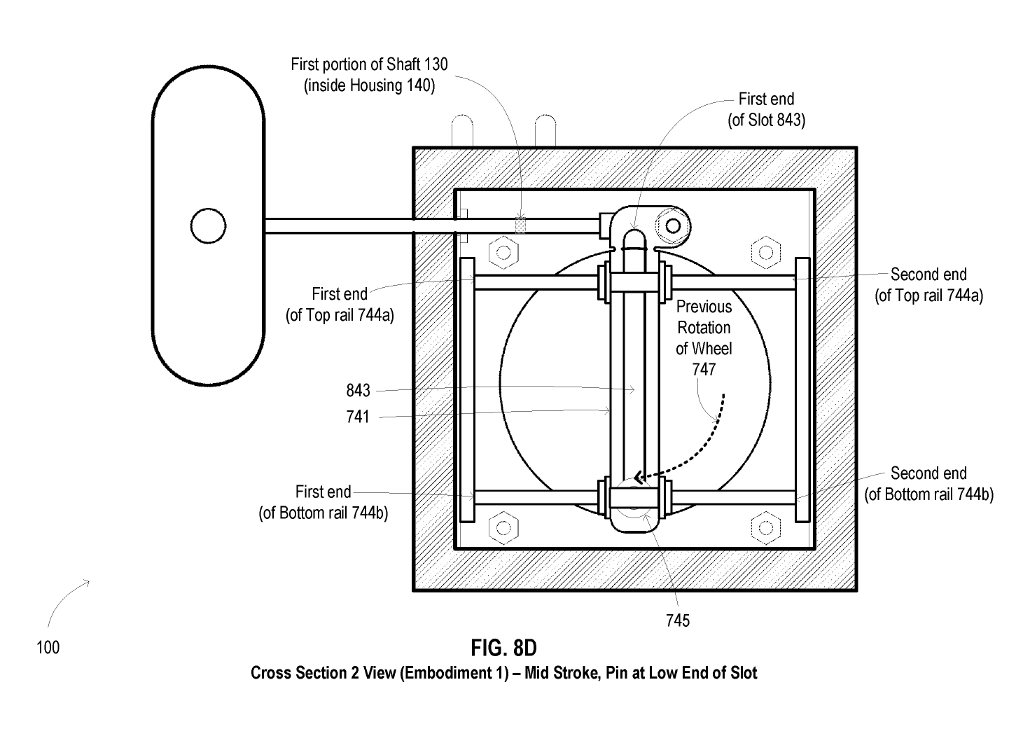

The mechanism housing 140 encloses part of the shaft 130 and also various components (not shown) that operate to move a portion of the shaft 130 in and out of the mechanism housing 140 during powered operation of a motor (not shown) that is enclosed in the motor housing 150. The various components enclosed in the mechanism housing 140 and the motor enclosed in the motor housing 150 are discussed later with reference to FIG. 7 through FIG. 8D.

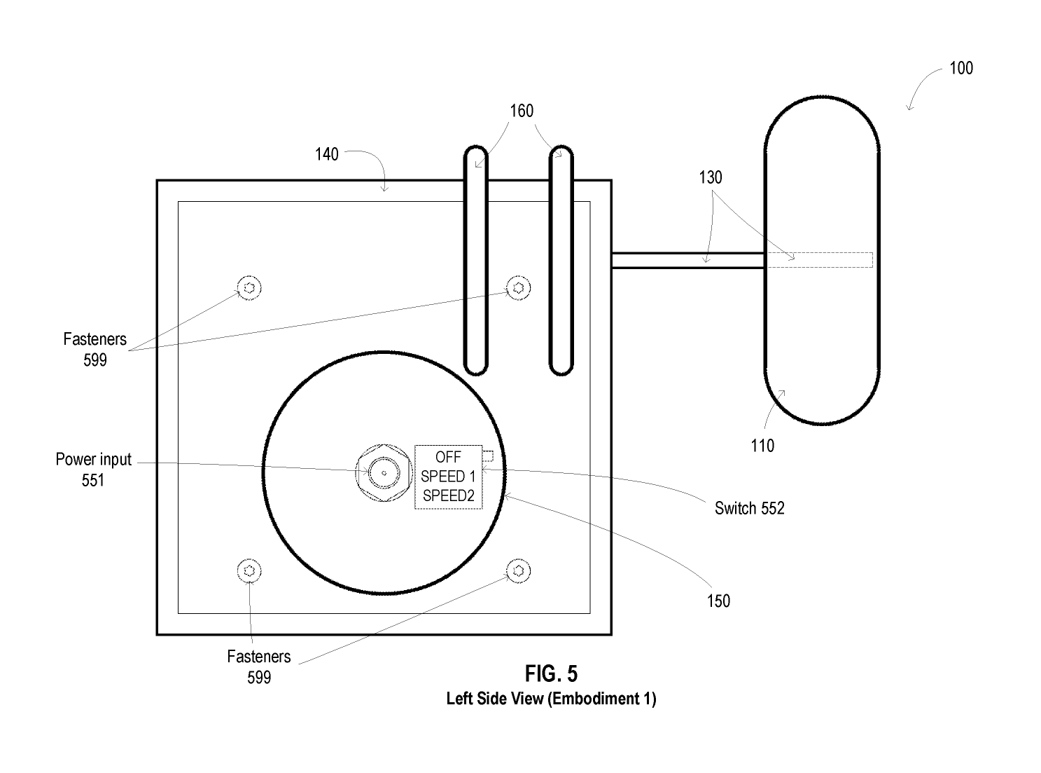

As shown in FIG. 5, a power input 551 is positioned at the left side of the motor housing 150, and is configured to deliver power to a motor (shown in FIG. 7). The power input 551 may be one or more batteries that are positioned inside the motor housing 150 (not shown), or may be an interface (shown) configured to receive an external power source.

The apparatus 100 may include a power switch 552 to turn power on and off to the motor (shown in FIG. 7) as would be understood in the art. In some embodiments, as shown in FIG. 5, the power switch 552 may be configured to increase or decrease power delivered to the motor so as to decrease or increase the speed at which the motor turns and to thereby decrease or increase the speed at which the shaft and sensory component move. Other switches could be added to control the direction the motor turns, and thereby control the direction of linear motion of the shaft.

Also shown are various fasteners 599 that are used to couple the motor housing 150 and the mechanism housing 140 to each other.

### Uses of the Apparatus

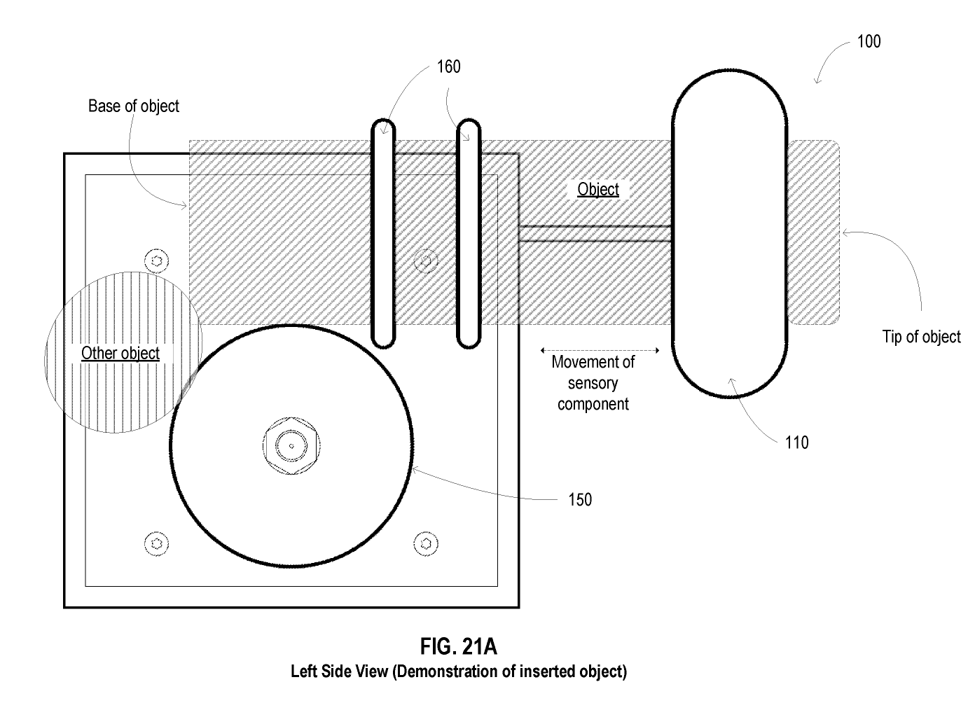

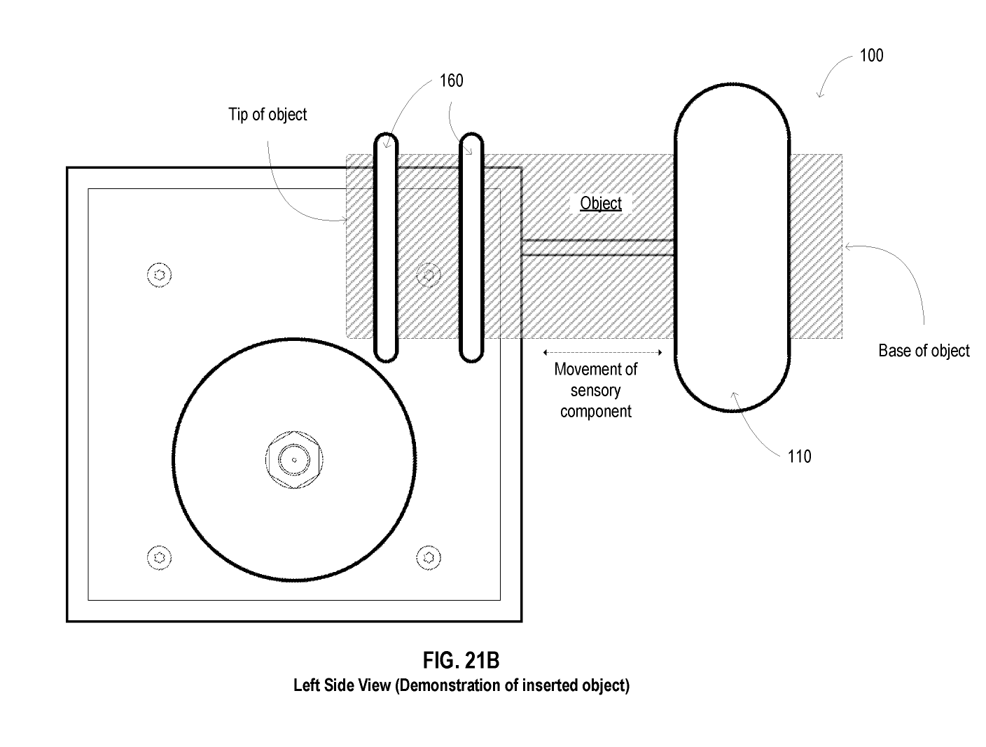

Different uses of the ejaculation promotion apparatus 100 are illustrated in FIG. 21A and FIG. 21B. In FIG. 21A, a tip of an object (e.g., a user's genital organ, such as a penis) is inserted through the support rings 160 and then through the sensory component 110. During operation of the apparatus 100 in accordance with FIG. 21A, the support rings 160 generally stay in contact with the same part of the object (e.g. approximate the base of the object where the object extends from the user's body or other thing), and the sensory component 110 makes contact with different parts of the object as the sensory component 110 is moved along the object by movement of a portion of the shaft 130 in and out of the mechanism housing 140.

In FIG. 21B, a tip of an object is inserted through the sensory component 110 and then through the support rings 160. During operation of the apparatus 100 in accordance with FIG. 21A, the support rings 160 generally stay in contact with the same part of the object (e.g. approximate the tip of the object), and the sensory component 110 makes contact with different parts of the object as the sensory component 110 is moved along the object by movement of a portion of the shaft 130 in and out of the mechanism housing 140.

The support rings 160 allow a user to have a hands-free experience during operation of the apparatus.

### Components of the Mechanism Housing 140 and the Motor Housing 150

Attention is now turned to FIG. 7, which depicts a first cross sectional view of the apparatus 100. Attention is also given to FIG. 8A through FIG. 8D, which each depict a second cross sectional view of the apparatus 100, and collectively illustrate movement of various components during operation of the apparatus 100.

As shown, the mechanism housing 140 encloses the following components: part of the shaft 130 (including a second end of the shaft 130); a bar 741; a top rail 744a; a bottom rail 744b; a pin 745; a wheel 747; rail supports 748; and an axle 749.

The bar 741 is coupled to the shaft at or near a second end of the shaft 130 by way of a shaft connector 742c, which is coupled to the bar 741 by way of a fastener 799a (or the shaft connector 742c could be part of the bar 741).

The bar 741 is also slidably coupled to a top rail 744a by way of a top connector 742a, and slidably coupled to a bottom rail 744b by way of a bottom connector 742b. The top connector 742a and the bottom connector 742b may be part of the bar, or can be separate components. A longitudinal axis between two ends of the top rail 744a, a longitudinal axis between two ends of the top rail 744b, and a longitudinal axis of the shaft 100 are parallel and spaced apart.

Opposite ends of the rails 774a and 744b are coupled to opposite rail supports 748 that fix the rails 744a and 744b in place relative to the mechanism housing 140.

The pin 745 is coupled to the wheel 747 (e.g., by way of a fastener 799b or other means of coupling), and the pin 745 extends outward from a right side of the wheel 747. A portion of the pin 745 that extends outward from the right side of the wheel 747 is inserted into a slot 843 of the bar 741.

The wheel 747 is coupled to an axle 749, which is coupled to a motor 753. The motor housing encloses various components, including the motor 753, part of the power input 551, and fasteners (e.g., a fastener 799c that couples the motor 753 to the motor housing 150).

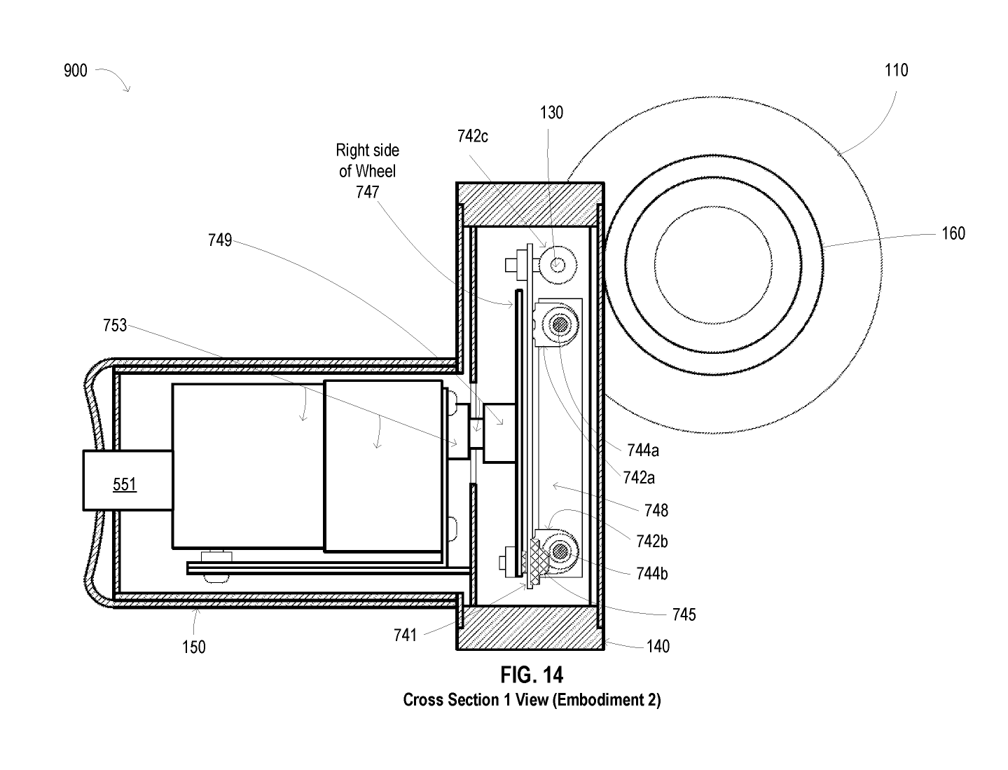

As shown in FIG. 7, certain components (e.g., the bar 741, the top rail 744a, and the bottom rail 744b) are positioned adjacent to the right side of the wheel 747, and other components (e.g., the axle 749 and the motor 753) are positioned adjacent to the left side of the wheel 747. This configuration of components is not required. For example, as shown in FIG. 14, certain components (e.g., a bar 1441, a top rail 1444a, a bottom rail 1444b) are positioned adjacent to the left side of a wheel 1447, and other components (e.g., an axle 1449 and a motor 1453) are positioned adjacent to the right side of the wheel 1447. Of course, a motor could be placed relative to different sides of a mechanism housing in different embodiments, and delivery of rotational movement from the motor to a wheel could be accomplished as would be known in the art (e.g., drive belts, chains, gears, screw shafts, or other).

### Operation

Operation of the apparatus 100 and its components is illustrated in FIG. 8A through FIG. 8D. The power input 551 provides power to the motor 753, which causes the motor 753 and the axle 749 to rotate. Rotation of the axle 749 causes the wheel 747 to rotate. Rotation by the wheel 747 moves the pin 745 between first and second ends of the slot 843. Movement of the pin 745 between the first and second ends of the slot 843 moves (e.g., slides) the bar 751 between corresponding first and second ends of the top rail 744a and the bottom rail 744b. Movement of the bar 751 between the corresponding first and second ends of the top rail 744a and the bottom rail 744b moves a portion of the shaft 130 in and out of the mechanism housing 140. When the apparatus 100 is operated, movement of the shaft 130 in and out of the mechanism housing 140 moves the sensory component 110 along an object so as to contact different portions of that object, which is not shown in FIG. 8A through FIG. 8D, but illustrated in FIG. 21A and FIG. 21B.

Each of the components described in the above paragraph are configured to perform the action described for that component (e.g., provide, rotate, move, contact). In particular: a portion of the shaft 130 is configured to move in and out of the housing 140 when the bar 741 slides along a first rail (e.g., the top rail 744a and/or the bottom rail 744b) between first and second ends of the first rail; a portion of the shaft 130 is configured to move in and out of the housing 140 when the pin 745 moves between first and second ends of the slot 843; a portion of the shaft 130 is configured to move in and out of the housing 140 when the wheel 747 rotates; the sensory component 110 is configured to contact different portions of an object when a portion of the shaft 130 moves in and out of the housing 140; the sensory component 110 is configured to contact different portions of an object when the bar 741 slides along a first rail (e.g., the top rail 744a and/or the bottom rail 744b) between first and second ends of the first rail; the sensory component 110 is configured to contact different portions of an object when the pin 745 moves between first and second ends of the slot 843; and the sensory component 110 is configured to contact different portions of an object when the wheel 747 rotates.

For purposes of illustration, different operational states of the apparatus are shown in FIG. 8A through FIG. 8D.

FIG. 8A depicts an operational state of the apparatus 100 after the wheel 747 rotated 90 degrees from an operational state illustrated in FIG. 8D. As shown, the pin 745 is closer to the middle of the slot 843 than to each of the ends of the slot 843 (e.g., depending on the designed length of the slot 843, the pin 745 could be positioned at approximately equal distances from the opposite ends of the slot 843). The bar 741 has traveled away from the second ends of the rails 744a and 744b, and the bar 741 has arrived at or near the first ends of the rails 744a and 744b. The first portion of the shaft 130 is outside the housing 140.

FIG. 8B depicts an operational state of the apparatus 100 after the wheel 747 rotated 90 degrees from the operational state illustrated in FIG. 8A. As shown, the pin 745 is at or near a second end of the slot 843. The bar 741 has traveled away from the first ends of the rails 744a and 744b, and the bar 741 is traveling towards the second ends of the rails 744a and 744b. The bar 741 is closer to the middle of the rails 744a and 744b than to each of the ends of the rails 744a and 744b (e.g., depending on the designed positions of the first and second ends of the rails 744a and 744b, the bar 741 may be positioned at approximately equal distances from the ends of the rails 744a and 744b). The first portion of the shaft 130 is inside the housing 140 traveling away from a wall of the housing 140 where the shaft 130 exits the housing 140.

FIG. 8C depicts an operational state of the apparatus 100 after the wheel 747 rotated 90 degrees from the operational state illustrated in FIG. 8B. As shown, the pin 745 is at or near a second end of the slot 843. As shown, the pin 745 is closer to the middle of the slot 843 than to each of the ends of the slot 843 (e.g., depending on the designed length of the slot, the pin 745 could be positioned at approximately equal distances from the ends of the slot 843). The bar 741 has traveled away from the first ends of the rails 744a and 744b, and the bar 741 has arrived at or near the second ends of the rails 744a and 744b. The first portion of the shaft 130 is inside of the housing 140 (e.g., the first portion of the shaft 130 has traveled the farthest away the first portion of the shaft 130 can travel from a wall of the housing 140 where the shaft 130 exits the housing 140).

FIG. 8D depicts an operational state of the apparatus 100 after the wheel 747 rotated 90 degrees from the operational state illustrated in FIG. 8C. As shown, the pin 745 is at or near a second end of the slot 843. When the pin 745 is at or near the second end of the slot 843, the bar 741 has traveled away from the second ends of the rails 744a and 744b, and the bar 741 is traveling towards the first ends of the rails 744a and 744b. The bar 741 is closer to the middle of the rails 744a and 744b than to each of the ends of the rails 744a and 744b (e.g., depending on the designed positions of the first and second ends of the rails 744a and 744b, the bar 741 may be positioned at approximately equal distances from the ends of the rails 744a and 744b). The first portion of the shaft 130 is traveling towards a wall of the housing 140 where the shaft 130 exits the housing 140.

### Alternative Designs

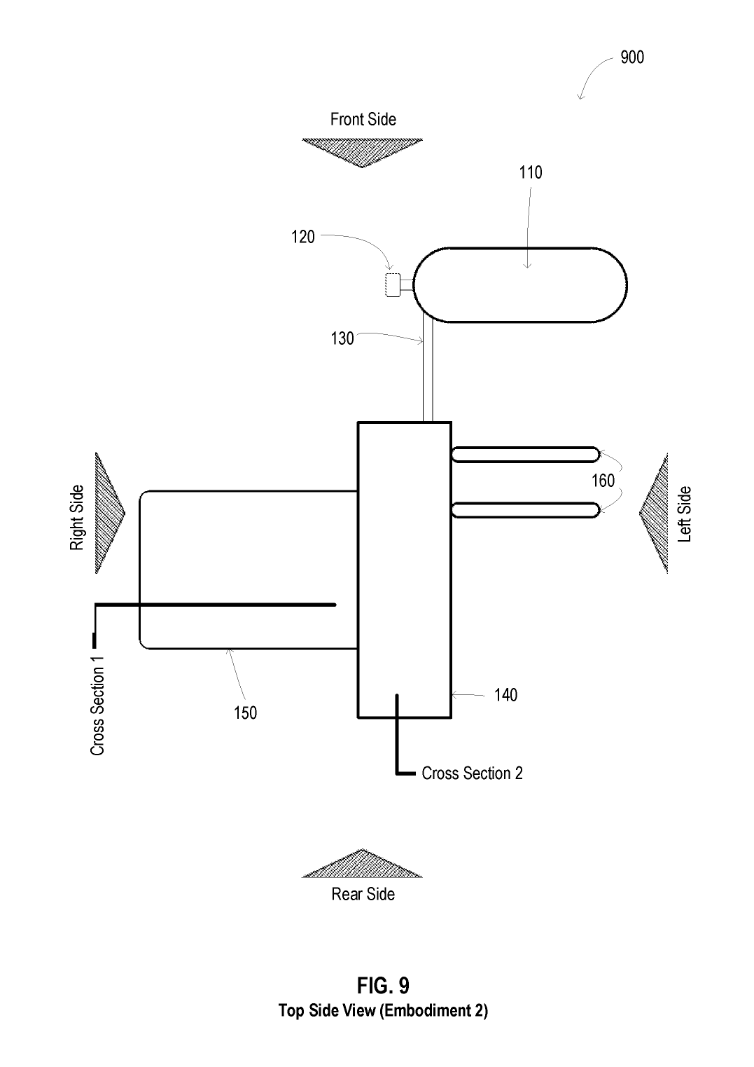

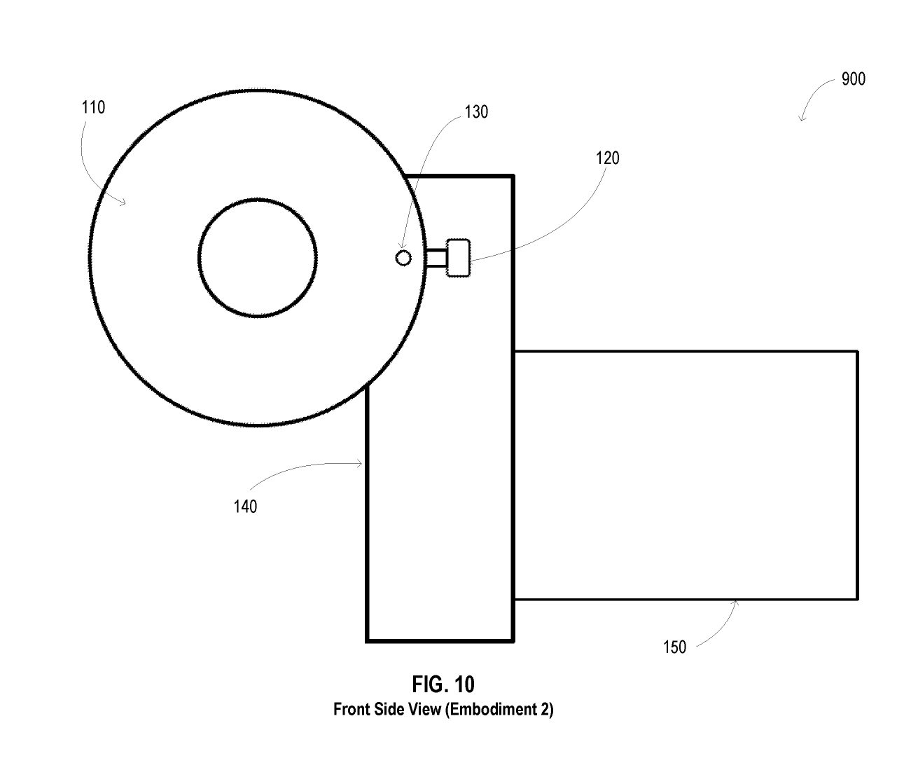

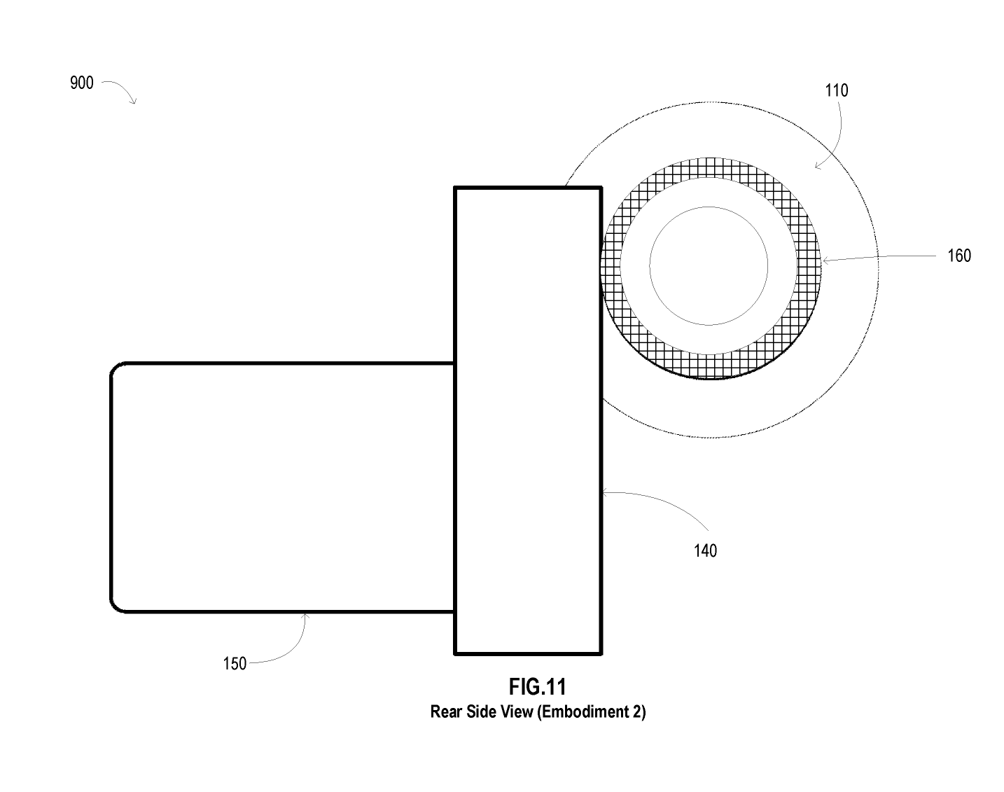

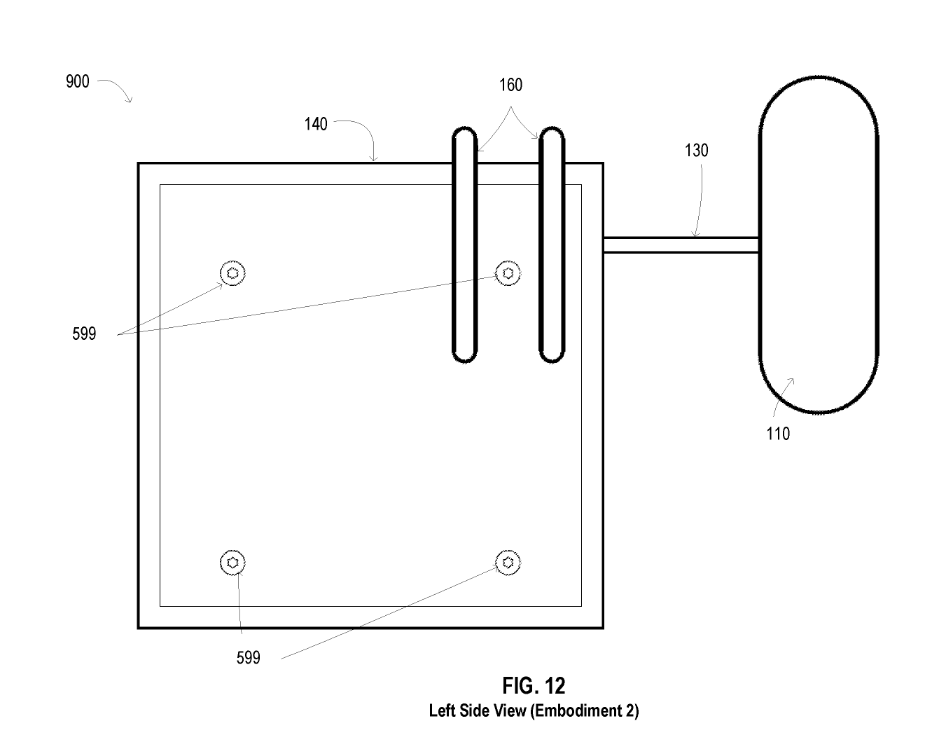

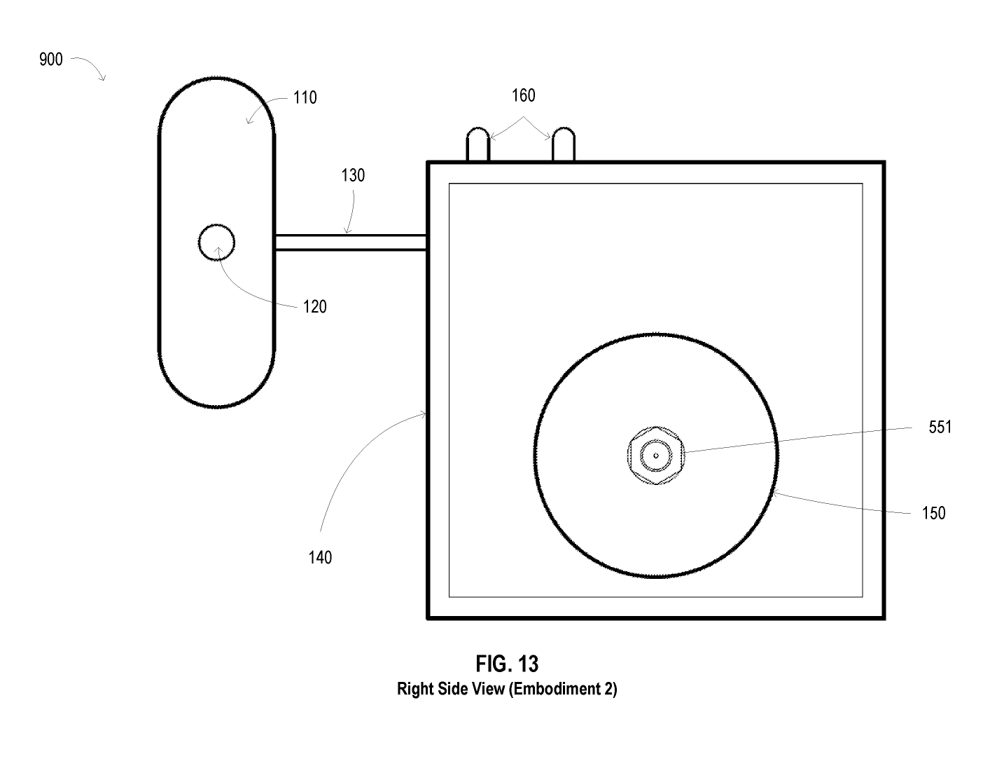

Alternative designs for an ejaculation promotion apparatus are contemplated. One alternative design is shown in FIG. 9 through FIG. 14, which respectively depict top side, front side, rear side, left side, right side, and cross sectional views of an apparatus 900. As shown, the apparatus 900 includes similar components as the apparatus 100 of FIG. 1A through FIG. 8D, but in a different configuration. In the different configuration, the motor housing 150 and its contents (e.g., the motor 753, the power input 551) are positioned on the right side of the mechanism housing 140, and the axle 749 couples to the right side of the wheel 747. The pin 745 couples to the left side of the wheel 747, and various components are now positioned adjacent to the left side of the wheel 747 (e.g., the bar 741, the rails 744a and 744b, the rail supports 748, and others). The positions of the shaft 130 and the sensory component 110 are the same as their positions in the apparatus 100 of FIG. 1A through FIG. 8D. Placement of the motor housing 150 on the right side of the mechanism housing enables a different user experience where the motor housing 150 does not come in contact with an object inserted through both the sensory component 110 and the support rings 160, or with a thing from which the object extends outward. It is noted, however, that placement of the motor housing 150 on the left side of the mechanism housing 140 (as in FIG. 1A) can produce a vibration that can be sensed by the object when resting on the motor housing 150 (e.g., see the contact of the object in FIG. 21A) or sensed by another object when resting on the motor housing 150 (e.g., the “other object” in FIG. 21A, which could be another body part like a scrotum/testicles).

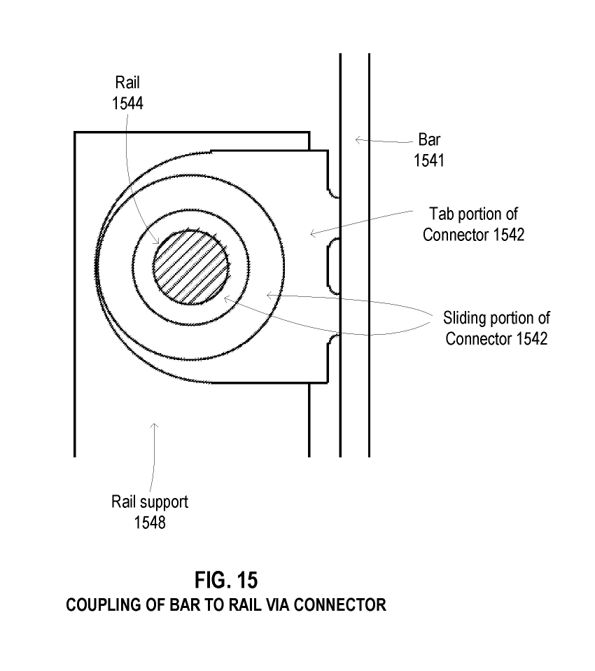

FIG. 15 depicts a coupling of a slidable bar to a rail for use in an ejaculation promotion apparatus. As shown, and a bar 1541 couples to the rail 1544 by way of a connector 1542. The rail 1544 is rigidly coupled to a rail support 1548. The connector 1542 may include one or more portions. In FIG. 15, the connector 1542 includes a tab portion coupled to the bar 1541 (or formed as part of the bar 1541), and a sliding portion coupled to the tab portion (or formed as part of the tab portion). The sliding portion couples to the rail 1544 and slides along the railing. A sliding portion shaped as a ring is shown; however, other designs are contemplated as would be understood by one of skill in the art. Sliding of the bar along the rail may be accomplished using different means known in the art—e.g., ball bearings, lubricant or another feature disposed between the rail and the connector.

FIG. 16 through FIG. 18B depict different types of sensory components.

FIG. 16 depicts a top side view of an ejaculation promotion apparatus with a sensory component 1610 comprising a sleeve. A sleeve is more cylindrical than a ring and is configured to cover a larger surface area of the object inserted into the sleeve as compared to the coverage of a ring. Sleeves may be composed of soft rubbers or polymers. One embodiment of a sleeve is a cap, which is a sleeve that has an enclosed front side. As shown, the sensory component 1610 couples to the shaft 130 at or near a first end of the shaft 130 in a similar way as the sensory component 110 coupled to the shaft 130. This way of coupling is referred to as a left side coupling configuration.

FIG. 17 depicts a top side view of an ejaculation promotion apparatus with a phallic-shaped sensory component 1710 coupled to a shaft using the left side coupling configuration. One example of a phallic-shaped sensory component is a dildo, which can be inserted into (e.g., penetrate) an object (e.g., a genital organ, such as a vagina or an anus). As shown, the sensory component 1710 couples to the shaft 130 at or near a first end of the shaft 130 in a similar way as the sensory component 110 coupled to the shaft 130.

FIG. 18A and FIG. 18B respectively depict a top side view and a front side view of an ejaculation promotion apparatus with a phallic-shaped sensory component 1810 coupled to the shaft 130 using an centered coupling configuration where the shaft 130 is inserted into a cavity at the center of the sensory component 1810.

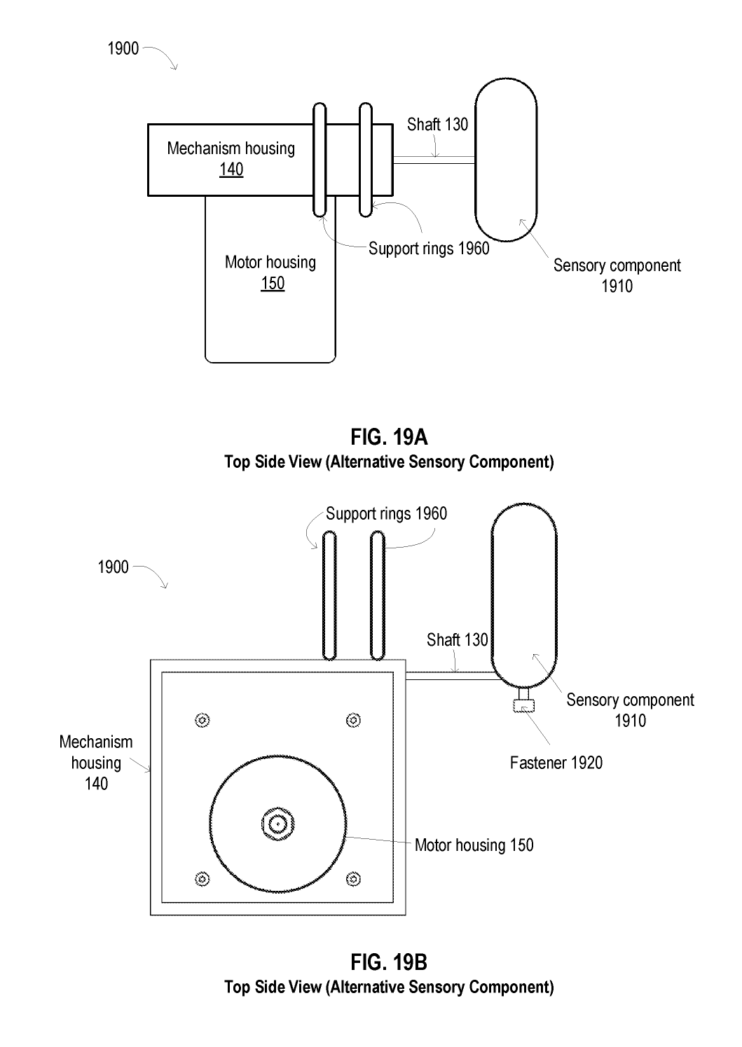

FIG. 19A and FIG. 19B respectively depict a top side view and a front side view of an ejaculation promotion apparatus with a ring-shaped sensory component 1910 coupled to the shaft 130 using a top-side coupling configuration. By comparison to the sensory component 110 of FIG. 1 through FIG. 8D, which extended away from the shaft 130 in a leftward direction, the sensory component 1910 extends away from the shaft 130 in an upward direction. Support rings 1960 couple to a top of the mechanism housing 140 instead of the left side of the mechanism housing 140 that coupled to the support rings 160 of FIG. 1A through FIG. 8D.

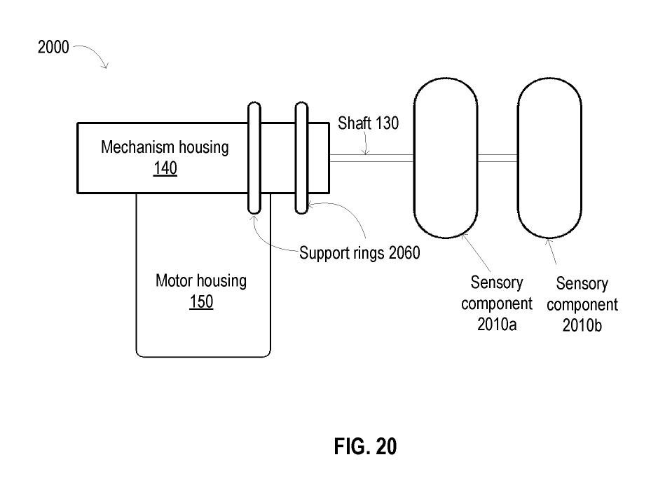

FIG. 20 depicts a top side view of an ejaculation promotion apparatus with multiple ring-shaped sensory components 2010a and 2020b coupled to the shaft 130 using the top-side coupling configuration introduced in FIG. 19A and FIG. 19B. Multiple sensory components could couple to the shaft of any apparatus using any coupling configuration.

### Variations

Different components can couple to each other using different means, including fasteners, adhesive, welding, frictional locks, or and other known means for coupling two components.

Various materials for each component are contemplated. For example, the shafts, bars, rails, pins and wheels may be formed from different types of materials, including plastic, metal, wood, or other known materials.

The sensory component may be formed from different types of materials, including rubber, plastic, polymer, resins, silicone, or other known materials. In some embodiments (e.g., FIG. 1A, FIG. 9, FIG. 16), the sensory components form a cavity through which an object (e.g., penis) is inserted. In other embodiments (e.g., FIG. 17, FIG. 18A), the sensory components form an outer shell or solid mass that is configured to be inserted into a cavity of an object (e.g., vagina, anus).

The sensory components can have any shape, including any desired orifice, a ring shape, a sleeve shape, a phallic shape, or others known in the art. The sensory components can be self-lubricating, electrically charged, motion sensing, or transmit information with a series of sensors to a computer software. Sleeves, rings, phallic-shaped sensory components, and other types of sensory components may have ridges, bumps, and grooves on surfaces of the sensory components to diversify sensation as the sensory component moves along in contact with an object inserted into or penetrated by the sensory component.

The shafts and rails can be any shape, including cylindrical, other tube-like shapes, rectangular prism, other prisms, or other suitable shapes.

The position of the sensory device need not be as shown in the figures and can be coupled to the shaft at different portions of the shaft. The position of a sensory component can be adjusted during use to increase user satisfaction. In one embodiment, the fastener 120 is a thumb screw that can be easily turned during operation to unlock and lock the sensory component 110 from the shaft 130.

Length of movement by the shaft during operation can be varied depending on the size of the wheel or other gearing like a Whitworth Quick Return mechanism. The size of the apparatus can be varied depending on the desired movement of the shaft.

Different motors can be used to provide varying levels of power and varying levels of speed.

A vibrator may be added to provide a vibrating sensation to a user (e.g., to the object or other object in FIG. 21A). The vibrator may be housed in the motor housing, or in its own housing configured to be in contact with an object during use.

Positions of support rings can vary depending on the desired use of the various apparatuses that are shown to include support rings. Support rings can vary in size and material. Any number of support rings can be used, including one support ring. The support rings can have different shapes, including any orifice. A support ring could be an elastomeric ring. A support ring could alternatively comprise two straps attached to the apparatus at one end of each strap, and that couple to each other at or near an opposite end of each strap. A support ring can be any suitable device for attaching the apparatus to an object when the apparatus is used.

Each embodiment described above that included two rails can be modified to include only one rail (e.g., a top rail 744a, a bottom rail 744b, or a rail in a different position). Each embodiment described above that included two rails can be modified to include more than two rails.

When a first component is positioned near a particular end of a second component (e.g., a first end of the second component), that first component is at least closer to that particular end than an opposite end of the second component (e.g., a second end of the second component).

Other designs of scotch yokes can be used in place of the bar, rail(s), pin and wheel to produce linear motion of a shaft that is coupled to a sensory device. A Whitworth Quick Return mechanism could be added to the apparatus to vary the speed of an upstroke to the speed of a downstroke.

### Methods of Manufacture

The apparatuses described herein may be manufactured using different processes. One process includes the steps of: forming each of the components for a particular apparatus using selected materials for those components; and assembling the apparatus by coupling different components to achieve the different coupled relationships for components that are described herein. Different ways of forming components are contemplated, including: machining the components, molding the components, or other ways of forming components known in the art.

It is noted that different components can be formed as one component. For example, the following components could be combined to form a single module comprising the different components that were combined: a shaft and bar module; a wheel and pin module; a mechanism housing and rails module; and a mechanism housing and motor housing module.

The dimensions of components in the apparatus may vary depending on the embodiment. In one embodiment, the sensory component, shaft and the bar move at least x units of measurement in one direction of movement (e.g., over 2 inches). Length of movement can vary depending on the size of the wheel or gearing used in the mechanism housing.

### Other Features

Power delivered to the motor can be controlled by software or a mechanical switch in a way that rotates the wheel in either direction (at different times of operation) at different speeds, and so rotation of the wheel can change directions and speed during operation when desired. Particular amounts of wheel rotation, duration of wheel rotation, and/or speed of wheel rotation can be controlled by software so the sensory component provides a physical sensation onto an object that matches a visual sensation experienced by a user (e.g., a visual sensation from virtual reality or other imagery). Information can be programmed to a servo-motor operating based on software instructions added to the apparatus.

### Other Uses

Uses of the apparatuses disclosed herein are not limited to uses of ejaculation. promotion of genital organ as objects put in contact with the sensory components. In other uses, different types of objects may be inserted through a sensory component. Similarly, different types of objects may be penetrated by a sensory component.

in some uses, no sensory component is used the components in the mechanism housing are used for a different purpose than moving a sensory component).

In the above description, well-known structures and techniques known to one of ordinary skill in the art have not been shown in detail in order not to obscure the inventive aspects of the disclosure.

1. An ejaculation promotion apparatus, the apparatus comprising:
a sensory component coupled to a shaft at or near a first end of the shaft;
a bar coupled to the shaft at or near a second end of the shaft;
a first rail, wherein the bar is slidably coupled to the first rail; and
a pin coupled to a wheel,
wherein the wheel has a right side and a left side,
wherein the pin extends outward from the right side of the wheel, and
wherein a portion of the pin is inserted into a slot of the bar.

2. The apparatus of claim 1, wherein the apparatus further comprises:
a housing enclosing the wheel, the pin, the bar, the first rail, and a portion of the shaft.

3. The apparatus of claim 2, wherein the apparatus further comprises:
one or more support rings coupled to a left side of the housing.

4. The apparatus of claim 1, wherein the apparatus further comprises:
an axle coupled to the wheel; and
a motor coupled to the axle.

5. The apparatus of claim 4, wherein the bar and the first rail are positioned adjacent to the right side of the wheel, and wherein the motor is positioned adjacent to the left side of the wheel.

6. The apparatus of claim 4, wherein the bar and the first rail are positioned adjacent to the left side of the wheel, and wherein the motor is positioned adjacent to the right side of the wheel.

7. The apparatus of claim 1, wherein a longitudinal axis of the first rail and a longitudinal axis of the shaft are parallel and spaced apart.

8. The apparatus of claim 1, wherein a longitudinal axis of the shaft and a cross sectional plane of the sensory component are perpendicular to each other.

9. The apparatus of claim 1, wherein a portion of the shaft is configured to move in and out of a housing when the bar slides along the first rail between first and second ends of the first rail.

10. The apparatus of claim 1, wherein a portion of the shaft is configured to move in and out of a housing when the pin moves between first and second ends of the slot.

11. The apparatus of claim 1, wherein a portion of the shaft is configured to move in and out of a housing when the wheel rotates.

12. The apparatus of claim 1, wherein rotation by the wheel moves the pin between first and second ends of the slot, wherein the movement of the pin between the first and second ends of the slot moves the bar between first and second ends of the first rail, and wherein the movement of the bar between the first and second ends of the first rail moves a portion of the shaft in and out of a housing.

13. The apparatus of claim 1, wherein the sensory component is configured to contact different portions of an object when a portion of the shaft moves in and out of the housing.

14. The apparatus of claim 13, wherein the apparatus further comprises:
one or more support rings that are configured to contact the same portion of the object when the sensory component contacts different portions of the object.

15. The apparatus of claim 1, wherein the sensory component is configured to contact different portions of an object when a portion of the shaft moves in and out of the housing.

16. The apparatus of claim 1, wherein the sensory component is configured to contact different portions of an object when the bar slides along the first rail between first and second ends of the first rail.

17. The apparatus of claim 1, wherein the sensory component is configured to contact different portions of an object when the pin moves between first and second ends of the slot.

18. The apparatus of claim 1, wherein the sensory component is configured to contact different portions of an object when the wheel rotates.

19. The apparatus of claim 1, wherein the sensory component is a ring or a sleeve configured to receive a genital organ inserted through the sensory component.

20. The apparatus of claim 1, wherein the shape of the sensory component is a phallic shape configured to penetrate a genital organ.
